(19) United States
(12) Patent Application Publication
(10) Pub. No.: US 2024/0105163 A1
(43) Pub. Date: Mar. 28, 2024

(54) SYSTEMS AND METHODS FOR EFFICIENT SPEECH REPRESENTATION

(71) Applicant: JPMORGAN CHASE BANK, N.A., New York, NY (US)

(72) Inventors: Pheobe SUN, London (GB); Ruibo SHI, London (GB); Sean MORAN, London (GB)

(21) Appl. No.: 18/471,876

(22) Filed: Sep. 21, 2023

Related U.S. Application Data
(60) Provisional application No. 63/376,820, filed on Sep. 23, 2022.

(51) Int. Cl. G10L 15/06; G10L 15/16

(52) U.S. Cl. CPC G10L 15/063; G10L 15/16

(57) ABSTRACT

Systems and methods for efficient speech representation are disclosed. In one embodiment, a method for efficient speech representation may include training a teacher model using training data to get embeddings from intermediate and/or final layers of the teacher model; training a student model using training data processed with audio distortion to have outputs matching the embeddings from the teacher model; and injecting known hand-crafted audio features into intermediate or final layers of the student model.

### RELATED APPLICATIONS

This application claims priority to, and the benefit of, U.S. Provisional Patent Application 63/376,820, filed Sep. 23, 2022, the disclosure of which is hereby incorporated, by reference, in its entirety.

### BACKGROUND OF THE INVENTION

### 1. Field of the Invention

Embodiments relate to systems and methods for efficient speech representation.

### 2. Description of the Related Art

There are an increasing number of tasks in the speech machine learning domain (e.g., speech recognition, speaker identification, emotion detection, etc.). Each task relies on different audio features. To avoid training a new model from scratch for each new task, researchers now focus on training a task agnostic base model that learns a rich speech representation—acoustic and linguistic features in speech recordings. With a task-agnostic/base model, users only need to fine-tune this model to make it suitable to a specific user scenario. It is, however, costly to pre-train and to fine-tune the state-of-the-art best performing models because the best performing models are huge.

Researchers have used distillation methods to come up with more lightweight version of the powerful huge models. DistilHuBERT, for example, is a distilled version of the HuBERT model. DistilHuBERT has only 25% of the parameters as in HuBERT, and is trained using a student-teacher learning method to make the base/task-agnostic model (HuBERT) lighter by reducing the number of transformer layers (from 12 to 2). Some speech representation is lost, however, as indicated by the downstream task performances after this distillation process.

The current training of the lightweight model is not data efficient. To maintain the performance of the distilled model, huge dataset is still required. DistilHuBERT used the same amount of data (960 hours of speech recording) as what was used when pre-training the large model HUBERT. Such requirement on huge dataset makes the knowledge distillation process less useful for knowledge transfer and model compression in a scenario where the dataset of interest is scarce (e.g., speech recording of a low resource language).

### SUMMARY OF THE INVENTION

Embodiments may provide an enhanced distillation approach to better learn speech representation with audio distortion and knowledge injection. The approach provides users with a lightweight model to fine-tune for downstream tasks, and may remedy the loss of representation of DistilHuBERT; the approach also provides an efficient approach to pre-train a task-agnostic/base model.

Embodiments may use tailored pre-training strategies to improve speaker-specific or semantic-specific downstream tasks. Examples may include speech recognition, speaker verification, keyword spotting, emotion recognition, speech separation, etc.

Embodiments may increase the data efficiency in the distillation process. For example, the performance of the models using embodiments distilled using 100 hour data is significantly improved over conventional models.

According to an embodiment, a method for efficient speech representation may include: (1) training a teacher model using training data to get embeddings from intermediate and/or final layers of the teacher model; (2) training a student model using training data processed with audio distortion to have outputs matching the embeddings from the teacher model; and (3) injecting known hand-crafted audio features into intermediate or final layers of the student model.

According to another embodiment, a method for efficient speech representation may include: (1) receiving, by a speech representation learning computer program, audio training data; (2) training, by the speech representation learning computer program, a teacher model using the audio training data to generate target outputs; (3) adding, by the speech representation learning computer program, audio distortion to the audio training data; (4) training, by the speech representation learning computer program, a student model with the audio training data and audio distortion to mimic the target outputs; (5) injecting, by the speech representation learning computer program, a known audio feature into a layer of the student model, wherein workers guide the layer of the student model in learning the known audio feature; (6) providing, by the speech representation learning computer program, a neural network head to the student model; (7) training, by the speech representation learning computer program, the neural network head with a labeled dataset for a specific task; and (8) deploying, by the speech representation learning computer program, the student model with the neural network head to an application for the specific task.

In one embodiment, the teacher model and the student model each comprise a plurality of convolutional encoder layers and a plurality of transformer layers. The student model may be initiated with weights from the teacher model and keeps fewer transformer layers than the teacher model.

In one embodiment, the method may also include calculating, by the speech representation learning computer program, a worker loss for the student model, wherein the worker loss represents a difference between an output of the student model and the target outputs.

In one embodiment, the specific task may include speech recognition, speaker verification, keyword spotting, emotion recognition, and/or speech separation.

In one embodiment, the known audio feature may include Mel Frequency Cepstral Coefficients (MFCC), gammatone, Log power spectrum (LPS), FBank, and/or prosody.

In one embodiment, the audio distortion may include additive noise, reverberation, and/or clipping.

According to another embodiment, a system may include: a data source comprising audio training data; a downstream system executing a specific task; and an electronic device executing a speech representation learning computer program that may be configured to receive the audio training data from the data source, train a teacher model using the audio training data to generate target outputs; add audio distortion to the audio training data, train a student model with the audio training data and audio distortion to mimic the target outputs, inject a known audio feature into a layer of the student model, wherein workers guide the layer of the student model in learning the known audio feature, provide a neural network head to the student model, train the neural network head with a labeled dataset for the specific task, and deploy the student model with the neural network head to the downstream system.

In one embodiment, the teacher model and the student model each comprise a plurality of convolutional encoder layers and a plurality of transformer layers. The student model may be initiated with weights from the teacher model and keeps fewer transformer layers than the teacher model.

In one embodiment, the speech representation computer program may be configured to calculate a worker loss for the student model, wherein the worker loss represents a difference between an output of the student model and the target outputs.

In one embodiment, the specific task may include speech recognition, speaker verification, keyword spotting, emotion recognition, and/or speech separation.

In one embodiment, the known audio feature may include Mel Frequency Cepstral Coefficients (MFCC), gammatone, Log power spectrum (LPS), FBank, and/or prosody.

In one embodiment, the audio distortion may include additive noise, reverberation, and/or clipping.

According to another embodiment, a non-transitory computer readable storage medium, may include instructions stored thereon, which when read and executed by one or more computer processors, cause the one or more computer processors to perform steps comprising: receiving audio training data; training a teacher model using the audio training data to generate target outputs; adding audio distortion to the audio training data; training a student model with the audio training data and audio distortion to mimic the target outputs; injecting a known audio feature into a layer of the student model and guiding the layer of the student model in learning the known audio feature; providing a neural network head to the student model; training the neural network head with a labeled dataset for a specific task; and deploying the student model with the neural network head to an application for the specific task.

In one embodiment, the teacher model and the student model each comprise a plurality of convolutional encoder layers and a plurality of transformer layers. The student model may be initiated with weights from the teacher model and keeps fewer transformer layers than the teacher model.

In one embodiment, the non-transitory computer readable storage medium may also include instructions stored thereon, which when read and executed by one or more computer processors, cause the one or more computer processors to calculate a worker loss for the student model, wherein the worker loss represents a difference between an output of the student model and the target outputs.

In one embodiment, the specific task may include speech recognition, speaker verification, keyword spotting, emotion recognition, and/or speech separation.

In one embodiment, the known audio feature may include Mel Frequency Cepstral Coefficients (MFCC), gammatone, Log power spectrum (LPS), FBank, and/or prosody, and the audio distortion may include additive noise, reverberation, and/or clipping.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for efficient speech representation according to an embodiment;

FIG. 2 illustrates a method for efficient speech representation according to another embodiment; and

FIG. 3 depicts an exemplary computing system for implementing aspects of the present disclosure.

### DETAILED DESCRIPTION OF PREFERRED EMBODIMENTS

Embodiments relate to systems and methods for efficient speech representation. Embodiments modify the student-teacher pre-training approach to improve speech representation. Specifically, the pre-training stage may use 1) distorted data as the training input for the student model, and 2) extra parallel tasks (multi-task training) to force the model to learn known effective hand-crafted audio features, such as Mel-Frequency Cepstral Coefficients (MFCC), gammatone, Log power spectrum (LPS), FBank (i.e., Log Mel-filter bank coefficients), prosody, hand-crafted audio features with longer duration (e.g., MFCC_long, gammatone_long, lps_long, fbank_long), etc.

Embodiments may inject known effective hand-crafted audio features to the model distillation process to train a lightweight task-agnostic/base model. Embodiments may remedy the loss of performance from speech representations learned in standard distillation process, such as one that is learned in DistillHuBERT through the improved distillation process.

Embodiments may inject known effective knowledge using a multi-task learning scheme (to ask the model to learn a variety of things at the same time). When learnt, the model does not need to use the head for knowledge injection at the fine-tuning stage. As such, the end users can use a model as lightweight as the DistilHuBERT yet with stronger representation.

Embodiments may apply randomized audio distortion to the training data to make the learnt representation more robust to noise and degradation. Examples of audio distortion may include additive noise, reverberation, clipping, etc. The use of distorted data makes pretraining more efficient. For example, using 100 hours of distorted data to pre-train the distilled model can reach the same performance as the model trained using 960 hours of speech data in content-related and semantic-related downstream tasks.

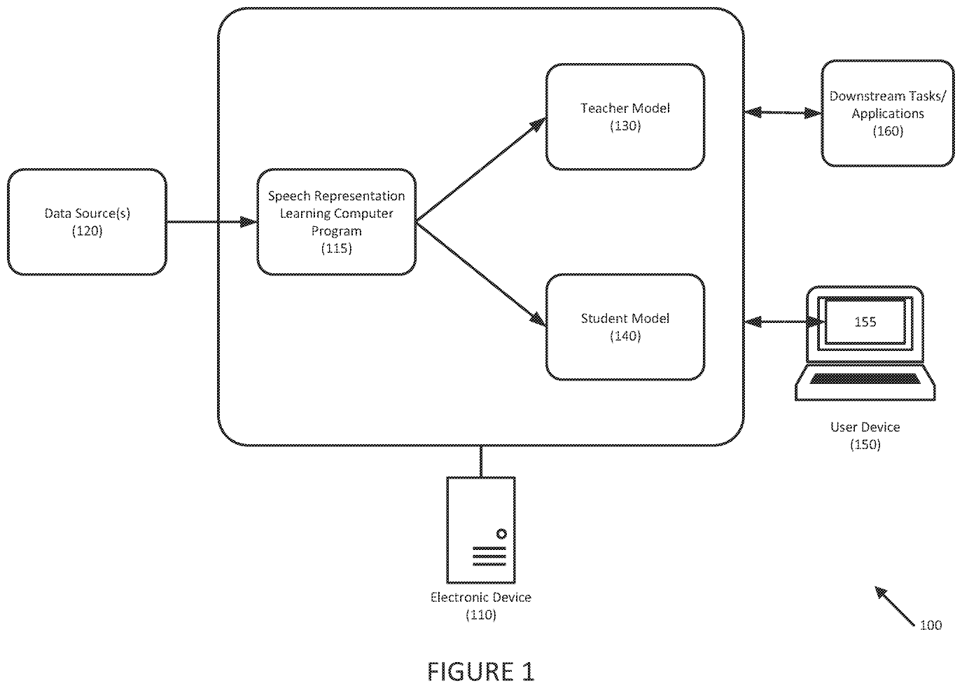

Referring to FIG. 1, a system for efficient speech representation is disclosed according to an embodiment. System 100 may include data source 110, which may provide audio data, speech representation learning computer program 115, which may process data from data source 110 to, for example, add audio distortion, teacher model 130 which may receive unprocessed data from data source 110, and student model 140 which may receive processed data from speech representation learning computer program 115. In one embodiment, speech representation learning computer program 115, teacher model 130, and student model 140 may be separate computer programs and may be executed by one or more electronic devices, including servers (e.g., physical and/or cloud-based), workstations, computers, etc.

Training data, including audio data that is labeled and unlabeled, may be provided by data source 120.

For example, teacher model 130 may have 7 convolutional encoder layers and 12 transformer layers. Student model 140 may be initiated using the same weights as teacher model 130 but may keep fewer than all of the transformer layers, such as 3. It should be noted that these numbers are exemplary only.

System 100 may further include user device 150, which may be any suitable device that may receive audio data and may use teacher model 130 and/or student model 140 to recognize text in the audio data. User device 150 may be any suitable electronic device, including servers (e.g., physical and/or cloud-based), computers (e.g., workstations, desktops, laptops, notebooks, tablets, etc.), smart devices (e.g., smart phones, smart watches, etc.), Internet of Things (IoT) appliances, kiosks (e.g., self-service devices, automated teller machines, etc.), etc. User device may execute program 155, which may be a computer program, an application, a distributed application, etc.

Workers (not shown) may be neural network layers appended, in parallel, on top of the output layer of student model 140. As part of the distillation process, workers may be trained to produce the target features, e.g., teacher produced features, hand-crafted features.

System 100 may further include one or more downstream tasks/applications 160. Downstream tasks/applications 160 may perform a voice-related task, such as speech recognition, speaker verification, keyword spotting, emotion recognition, speech separation, etc. Downstream tasks/applications 160 may receive student model 140 with task-specific neural network layers that are trained using a labeled dataset.

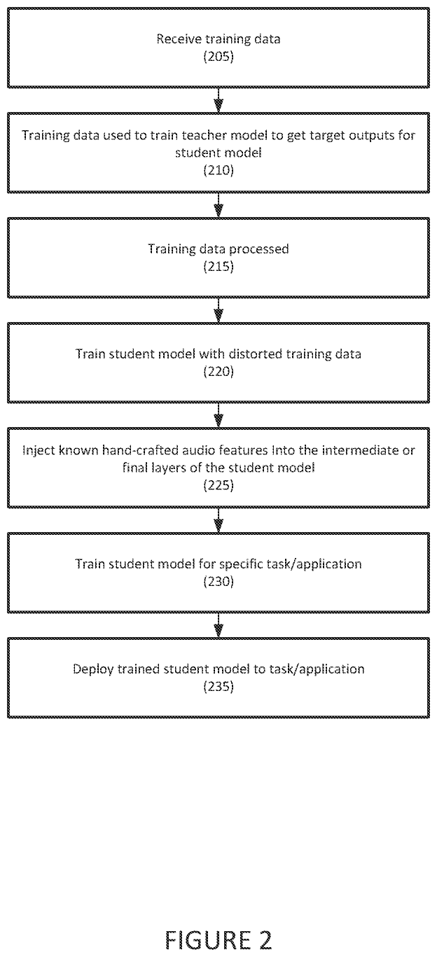

Referring to FIG. 2, a method for efficient speech representation is disclosed according to an embodiment. In step 205, a computer program, such a speech representation learning computer program, may receive training data, such as audio data, from a data source. In one embodiment, the training data may be historical data that has been previously processed. The learning process for the student model may not require any data labelling or transcription, and uses the raw audio data.

In step 210, the speech representation learning computer program may use the training data to train a teacher model to get embeddings (e.g., the target outputs for the student to learn) from the intermediate and/or final layers of the teacher model. For example, the speech representation learning computer program may provide the training data for the teacher model in order to get transformed data, such as features, to be used as the target output for the student model. These features are embeddings (e.g., numerical vectors) at the frame-level, from the output of transformer layers (intermediate or final) of the teacher model.

In step 215, the speech representation learning computer program may process the training data to, for example, include audio distortion. For example, the speech representation learning computer program may include additive noise, reverberation, clipping, etc.

In one embodiment, one or more audio distortion algorithms may be applied to the audio before it is provided as the input to the student model for training.

In step 220, for the distillation process (i.e., the student model learning process), the student model may be trained to mimic the embeddings from the teacher model. The student model may be trained so its outputs match the target outputs of the teacher model. In one embodiment, supervised learning may be used to train the student model. An example of such training is a combination of L1 and cosine loss may be used to train the student model.

In step 225, the speech representation learning computer program may inject known audio features, such as hand-crafted audio features, into the intermediate or final layers of the student model. In one embodiment, the injection may not be directly applied to the output. Instead, an injection network may adjust the weights of the student model via backward propagation.

For example, the known audio features may be presented as the learning target, not for the final output of the student model, but its intermediate layers. Therefore, they act as regularization for the intermediate layers. The goal is for the student network or part of the student network to be able to reproduce the desired hand-crafted features. Once the student model is trained, this injection network may not be used.

In one embodiment, workers may be used to inject the known audio features into the layers of the student model to guide the learning of the known audio features. For example, the workers may be set up to mimic the target output by reconstructing features including MFCC, gammatone, lps, thank, prosody, MFCC_long, gammatone_long, lps_long, fbank_long, etc. The gradient may be backpropagated to update the student model weights.

Embodiments may use a loss function, such as a worker loss. The loss function may be used to compute the errors between the student model's output and its target. This loss may be differentiated with respect to the parameters of the student model thereby updating its weights.

For example, the speech representation learning computer program may calculate a total loss based on the sum of a reconstruction loss and a similarity loss multiplied by a first coefficient, plus a worker loss multiplied by a second coefficient. The first and second coefficients may be set to default values (e.g., 0.5 each, 0.2 and 0.8, or any suitable combination of values), may vary based on machine learning, etc.

In step 230, the speech representation learning computer program may provide the student model with neural network layers and may train the neural network layers for a specific task with labeled datasets. For example, the neural network layers may be trained for speech recognition, speaker verification, keyword spotting, emotion recognition, speech separation, etc.

In step 235, the speech representation learning computer program may deploy the student model with the trained neural network to a specific task or application for the specific task.

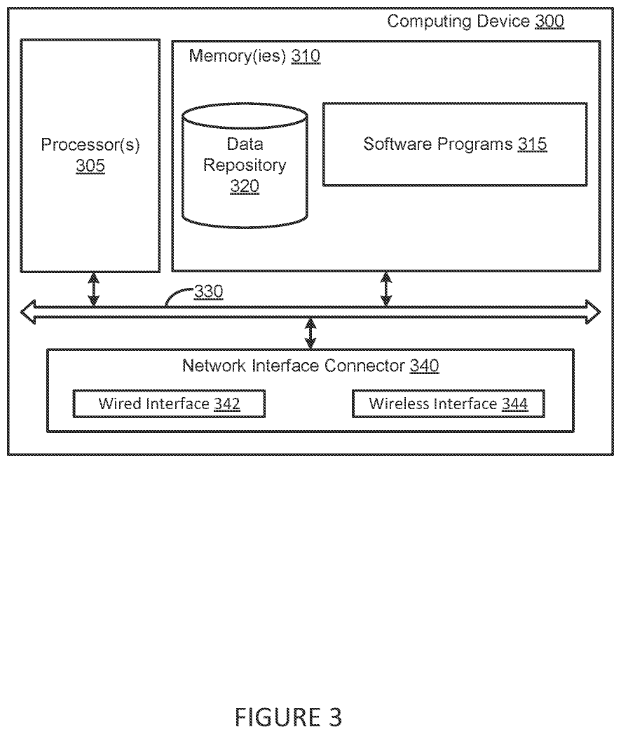

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosures of Chang et al, “DistilHuBERT: Speech Representation Learning by Layer-wise Distillation of Hidden-unit BERT,” available at doi.org/10.48550/arXiv.2110.01900, Guo et al., “Knowledge Distillation: A Survey” available at doi.org/10.48550/arXiv.2006.05525, and Park et al., “SpecAugment: A Simple Data Augmentation Method for Automatic Speech Recognition,” available at doi.org/10.48550/arXiv.1904.08779 are incorporated, by reference, in their entireties.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for efficient speech representation, comprising:
receiving, by a speech representation learning computer program, audio training data;
training, by the speech representation learning computer program, a teacher model using the audio training data to generate target outputs;
adding, by the speech representation learning computer program, audio distortion to the audio training data;
training, by the speech representation learning computer program, a student model with the audio training data and audio distortion to mimic the target outputs;
injecting, by the speech representation learning computer program, a known audio feature into a layer of the student model, wherein workers guide the layer of the student model in learning the known audio feature;
providing, by the speech representation learning computer program, a neural network head to the student model;
training, by the speech representation learning computer program, the neural network head with a labeled dataset for a specific task; and
deploying, by the speech representation learning computer program, the student model with the neural network head to an application for the specific task.

2. The method of claim 1, wherein the teacher model and the student model each comprise a plurality of convolutional encoder layers and a plurality of transformer layers.

3. The method of claim 2, wherein the student model is initiated with weights from the teacher model and keeps fewer transformer layers than the teacher model.

4. The method of claim 1, further comprising:
calculating, by the speech representation learning computer program, a worker loss for the student model, wherein the worker loss represents a difference between an output of the student model and the target outputs.

5. The method of claim 1, wherein the specific task comprises speech recognition, speaker verification, keyword spotting, emotion recognition, and/or speech separation.

6. The method of claim 1, wherein the known audio feature comprises Mel Frequency Cepstral Coefficients (MFCC), gammatone, Log power spectrum (LPS), FBank, and/or prosody.

7. The method of claim 1, wherein the audio distortion comprises additive noise, reverberation, and/or clipping.

8. A system, comprising:
a data source comprising audio training data;
a downstream system executing a specific task; and
an electronic device executing a speech representation learning computer program that is configured to receive the audio training data from the data source, train a teacher model using the audio training data to generate target outputs; add audio distortion to the audio training data, train a student model with the audio training data and audio distortion to mimic the target outputs, inject a known audio feature into a layer of the student model, wherein workers guide the layer of the student model in learning the known audio feature, provide a neural network head to the student model, train the neural network head with a labeled dataset for the specific task, and deploy the student model with the neural network head to the downstream system.

9. The system of claim 8, wherein the teacher model and the student model each comprise a plurality of convolutional encoder layers and a plurality of transformer layers.

10. The system of claim 9, wherein the student model is initiated with weights from the teacher model and keeps fewer transformer layers than the teacher model.

11. The system of claim 8, wherein the speech representation computer program is configured to calculate a worker loss for the student model, wherein the worker loss represents a difference between an output of the student model and the target outputs.

12. The system of claim 8, wherein the specific task comprises speech recognition, speaker verification, keyword spotting, emotion recognition, and/or speech separation.

13. The system of claim 8, wherein the known audio feature comprises Mel Frequency Cepstral Coefficients (MFCC), gammatone, Log power spectrum (LPS), FBank, and/or prosody.

14. The system of claim 8, wherein the audio distortion comprises additive noise, reverberation, and/or clipping.

15. A non-transitory computer readable storage medium, including instructions stored thereon, which when read and executed by one or more computer processors, cause the one or more computer processors to perform steps comprising:
receiving audio training data;
training a teacher model using the audio training data to generate target outputs;
adding audio distortion to the audio training data;
training a student model with the audio training data and audio distortion to mimic the target outputs;
injecting a known audio feature into a layer of the student model and guiding the layer of the student model in learning the known audio feature;
providing a neural network head to the student model;
training the neural network head with a labeled dataset for a specific task; and
deploying the student model with the neural network head to an application for the specific task.

16. The non-transitory computer readable storage medium of claim 15, wherein the teacher model and the student model each comprise a plurality of convolutional encoder layers and a plurality of transformer layers.

17. The non-transitory computer readable storage medium of claim 16, wherein the student model is initiated with weights from the teacher model and keeps fewer transformer layers than the teacher model.

18. The non-transitory computer readable storage medium of claim 15, further including instructions stored thereon, which when read and executed by one or more computer processors, cause the one or more computer processors to calculate a worker loss for the student model, wherein the worker loss represents a difference between an output of the student model and the target outputs.

19. The non-transitory computer readable storage medium of claim 15, wherein the specific task comprises speech recognition, speaker verification, keyword spotting, emotion recognition, and/or speech separation.

20. The non-transitory computer readable storage medium of claim 15, wherein the known audio feature comprises Mel Frequency Cepstral Coefficients (MFCC), gammatone, Log power spectrum (LPS), FBank, and/or prosody, and the audio distortion comprises additive noise, reverberation, and/or clipping.
